(19) United States
(12) Patent Application Publication
(10) Pub. No.: US 2012/0197783 A1
(43) Pub. Date: Aug. 2, 2012

(54) DYNAMIC SAVINGS ALLOCATION METHOD AND PURCHASING MODEL

(75) Inventors: Chad Hunter, Charlotte, NC (US); Christopher Nygren, Charlotte, NC (US); Debashis Ghosh, Charlotte, NC (US); Srinath Nagarajan, Waltham, MA (US)

(73) Assignee: BANK OF AMERICA CORPORATION, Charlotte, NC (US)

(21) Appl. No.: 13/015,078

(22) Filed: Jan. 27, 2011

(51) Int. Cl. G06Q 40/00

(52) U.S. Cl. 705/39

(57) ABSTRACT

A system and method for providing a dynamic savings allocation account. The dynamic savings allocation account includes customer-defined savings categories within the account that act as sub-accounts. The customer may create savings categories and set parameters such as the goal amount to be reached, the time to reach the goal, how much or what percentage to be allocated to each category per deposit, etc. As the customer deposits funds into the dynamic savings allocation account, the deposit is automatically allocated to each savings category as defined by the customer. As goals are reached, customers may opt to take advantage of group purchasing benefits offered by the financial institution for some in-demand items. Alternatively, the financial institution, in partnering with third-party vendors may perform targeted sales campaigns.

### FIELD

In general, embodiments herein disclosed relate to methods and systems for financial investment and purchasing models and, more specifically, providing a dynamic savings allocation account that allows for financial institution customers to create savings categories for specific targeted savings.

### BACKGROUND

Consumer financial institution customers today are very limited in how they can organize savings deposits held in their financial accounts. These deposits—whether in a savings, checking, money market, or similar account—are lumped into one general sum and cannot be allocated for multiple specific savings goals. Unfortunately, this leads to many financial institution customers utilizing the “envelope” method of savings allocation where the customers do not deposit savings into financial accounts or withdraw savings from the accounts and categorize their savings at home (such as in separate labeled envelopes). Of course, this method is contrary to a financial institution's goals, as a financial institution prefers to have the highest deposit base possible.

In some cases, account names can be customized, but that still leaves the deposits within the account in one general pool. Thus, in order to segregate savings funds electronically, some customers have begun to open multiple accounts and naming them to reflect different savings goals (e.g., vacation, new car, holiday, etc.). However, beyond just the inherent added complexity with this method (multiple accounts to manage); there is also a limit to the number of accounts most financial institutions will allow customers to open. Further, there may be added fees associated with owning numerous accounts, as well as additional costs and maintenance to the financial institution for hosting multiple accounts.

Thus, a need currently exists for a dynamic savings allocation method in which a customer may readily allocate funds to savings categories within a single account. Furthermore, a need exists to provide a method where a group of financial institution customers saving for similar items can obtain group sales benefits and discounts or targeted sales campaigns.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present invention provides for a dynamic savings allocation account that allows for customers to create sub-accounts, referred to herein as savings categories, within a single account. The customer may create savings categories (e.g., “vacation,” “new car,” “television,” “rainy day,” etc.) and set parameters such as the goal amount to be reached, the time to reach the goal, how much or what percentage to be allocated to each category per deposit, etc. As the customer deposits funds into the dynamic savings allocation account, the deposit is automatically allocated to each savings category as defined by the customer. As goals are reached, new savings categories may be formed and/or future deposits allocated to other savings categories.

Thus, in a first embodiment of the invention, a method for dynamic savings allocation is provided. The method includes establishing, for a financial institution customer, a dynamic savings allocation account. The account includes at least one customer-defined savings category. The method further includes receiving a deposit amount for the account. Upon receipt of a deposit, a computing device processor determines, for the deposit amount, an amount or amounts to be allocated to the at least one customer-defined savings category. The amount is then allocated to the savings categories.

In a specific embodiment, the at least one customer-defined savings category includes parameters selected by the customer such as a category name, a goal amount desired to be saved, a percentage of total savings to be allocated to the savings category, a time period to reach a desired amount, or a combination thereof.

In another specific embodiment, the at least one customer-defined savings category includes parameters comprising a goal amount desired to be saved, a percentage of total savings to be allocated to the savings category, and a time period to reach a desired amount. In such embodiments, the customer may define any two of the parameters and the third parameter is automatically generated.

In still further specific embodiments the customer defines an amount to be deposited to the dynamic savings allocation account. The amount to be deposited to the dynamic savings allocation account can be a recurring amount that is deposited each customer-defined time period.

Moreover, in another specific embodiment, the amount to be deposited to the dynamic savings allocation account may be automatically drafted from another financial institution account or deposited by a third-party.

In some embodiments, the at least one customer-defined savings category includes a category name that is manually inputted by the customer or is selected from a list of names provided to the customer.

In some specific embodiments, at least one of the at least one customer-defined savings categories includes a category name that represents a specific consumer product and a goal amount that is approximately equal to the consumer cost of the specific consumer product.

In another specific embodiment, the goal amount is automatically inputted by the computing device processor based on the category name inputted that represents a specific consumer product.

In another specific embodiment, the dynamic savings allocation account includes more than one customer-defined savings categories. In some embodiments, each customer-defined savings category includes a percentage of total savings in the account to be allocated to each savings category parameter where the sum of the percentages of all savings categories equal 100%.

In specific embodiments, no further amount is to be allocated to a savings category in which the desired goal has been reached.

In some particular specific embodiments, the customer defines a specific amount to be allocated to one or more savings categories for each deposit.

In another aspect of the invention, a system for dynamic savings allocation is provided. The system includes a dynamic savings allocation account that includes one or more savings categories. The one or more savings categories include customer-defined parameters for savings allocation such that a deposit received for the account is automatically allocated to the one or more savings categories in a desired manner.

In a specific embodiment, the one or more customer-defined savings categories include parameters selected by the customer comprising a category name, a goal amount desired to be saved, a percentage of total savings to be allocated to the savings category, a time period to reach a desired amount, or a combination thereof.

In further specific embodiments, the one or more customer-defined savings categories include parameters comprising a goal amount desired to be saved, a percentage of total savings to be allocated to the savings category, and a time period to reach a desired amount. The customer may define two of the parameters and the third parameter is automatically generated.

Additionally, in some specific embodiments, an amount to be deposited to the dynamic savings allocation account is a recurring amount that is deposited each customer-defined time period.

In more specific embodiments, the amount to be deposited to the dynamic savings allocation account is automatically drafted from another financial institution account or is deposited by a third-party.

Other specific embodiments, the one or more customer-defined savings categories include a category name that is manually inputted by the customer or is selected from a list of names provided to the customer.

In other specific embodiments, at least one of the one or more customer-defined savings categories includes a category name that represents a specific consumer product and a goal amount that is approximately equal to the consumer cost of the specific consumer product. In some embodiments, the goal amount may be automatically determined based on the category name inputted that represents a specific consumer product.

In further embodiments, the dynamic savings allocation account includes more than one customer-defined savings category. In some embodiments, each customer-defined savings category includes a percentage of total savings in the account to be allocated to each savings category parameter, wherein the sum of the percentages of all savings categories equal 100%.

In specific embodiments, no further amount is to be allocated to a savings category in which the desired goal has been reached.

In some particular specific embodiments, the customer defines a specific amount to be allocated to one or more savings categories for each deposit.

In another aspect of the invention, a method for dynamic savings allocation is provided. The method includes providing a dynamic savings allocation account to a customer. The account is capable of having one or more customer-defined savings categories. After the customer has created one or more customer-defined savings categories within the account, a deposit amount is received for the account. A computing device process determines, for the deposit amount, an amount to be allocated to the one or more customer-defined savings categories. Finally, the determined amount to the one or more customer-defined savings categories is allocated.

In a specific embodiment, the one or more customer-defined savings categories include parameters selected by the customer comprising a category name, a goal amount desired to be saved, a percentage of total savings to be allocated to the savings category, a time period to reach a desired amount, or a combination thereof.

In further specific embodiments, the one or more customer-defined savings categories include parameters comprising a goal amount desired to be saved, a percentage of total savings to be allocated to the savings category, and a time period to reach a desired amount. The customer may define two of the parameters and the third parameter is automatically generated.

Additionally, in some specific embodiments, an amount to be deposited to the dynamic savings allocation account is a recurring amount that is deposited each customer-defined time period.

In more specific embodiments, the amount to be deposited to the dynamic savings allocation account is automatically drafted from another account or is deposited by a third-party.

Other specific embodiments, the one or more customer-defined savings categories include a category name that is manually inputted by the customer or is selected from a list of names provided to the customer.

In other specific embodiments, at least one of the one or more customer-defined savings categories includes a category name that represents a specific consumer product and a goal amount that is approximately equal to the consumer cost of the specific consumer product. In some embodiments, the goal amount may be automatically determined based on the category name inputted that represents a specific consumer product.

In further embodiments, the dynamic savings allocation account includes more than one customer-defined savings category. In some embodiments, each customer-defined savings category includes a percentage of total savings in the account to be allocated to each savings category parameter, wherein the sum of the percentages of all savings categories equal 100%.

In specific embodiments, no further amount is to be allocated to a savings category in which the desired goal has been reached.

In some particular specific embodiments, the customer defines a specific amount to be allocated to one or more savings categories for each deposit.

In a further aspect of the invention, a computer program product is provided. The computer program product includes a non-transitory computer-readable medium. The medium includes a first set of codes for causing a computer to determine, for a received deposit amount for a dynamic savings allocation account, an amount to be allocated to one or more customer-defined savings categories. The medium further includes a second set of codes for causing a computer to deposit the deposit amount in the dynamic savings allocation account and allocate a portion of the deposit amount to the one or more customer-defined savings categories.

In specific embodiments, the computer program product further includes a third set of codes for causing a computer to receive parameters for the one or more customer-defined savings categories. The parameters are selected by a customer and include a name, a goal amount desired to be saved, a percentage of total savings or deposit amount to be allocated to the savings category, a time period to reach a desired amount, or a combination thereof. In some specific embodiments, the computer program product may further include a fourth set of codes for causing a computer to automatically generate at least one of the parameters based on other parameters defined by the customer.

In other specific embodiments, the computer program product further includes a fifth set of codes for causing a computer to present an electronic input form to the customer for defining the parameters for the one or more customer-defined savings categories.

In some embodiments, the computer program product may include a sixth set of codes for causing a computer to automatically input a goal amount for at least one of the one or more customer-defined savings categories. The goal amount may be approximately equal to the cost of a specific consumer product or service which may be identified by other parameters defined by the customer.

In further embodiments, the computer program product may include a seventh set of codes for causing a computer to generate more than one customer-defined savings categories within the dynamic savings allocation account.

In still further embodiments, the computer program product may include an eighth set of codes for causing a computer to generate an alert to a customer when a goal amount is reached for the one or more customer-defined savings categories.

Thus, embodiments herein described in more detail below provide dynamic savings allocation accounts and, specifically, accounts that allow for customers to create sub-accounts or savings categories within a single account. The customer may create savings categories and set parameters such as the goal amount to be reached, the time to reach the goal, how much to be allocated to each category per deposit, etc. As the customer deposits funds into the dynamic savings allocation account, the deposit is automatically allocated to each savings category as defined by the customer. As goals are reached, new savings categories may be formed and/or future deposits allocated to other savings categories. Further, as goals are reached, customers may opt to take advantage of group purchasing benefits offered by the financial institution for some in-demand items. Alternatively, the financial institution, in partnering with third-party vendors may perform targeted sales campaigns.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flow chart of a method for dynamic savings allocation utilizing a dynamic savings allocation account, in accordance with embodiments of the present invention;

FIG. 2 is a flow chart of a method for dynamic savings allocation utilizing a dynamic savings allocation account, in accordance with embodiments of the present invention;

FIG. 3 is one embodiment of the present invention illustrating a customer input menu for creating a new savings category or manipulating parameters of an existing savings category;

FIG. 4 is one embodiment of the present invention illustrating a dynamic savings allocation account with five savings categories;

FIG. 5 is one embodiment of the present invention illustrating a dynamic savings allocation account having five savings categories, wherein one category has reached a predetermined goal amount;

FIG. 6 is one embodiment of the present invention illustrating a dynamic savings allocation account with five savings categories, wherein one category has reached a predetermined goal amount due to a price drop in the product;

FIG. 7 is a flowchart of a method for providing financial services including a group sales model and/or targeted sales to the customer based on their savings categories, in accordance with embodiments of the present invention.

FIG. 8 is a diagram illustrating alternative opt in-type programs for savings categories potentially available to a customer, in accordance with embodiments of the present invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution. A financial institution may include a bank, an investment firm, a brokerage firm, or the like.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Present embodiments of the invention provide for a system and method for providing a dynamic savings allocation account. The dynamic savings allocation account includes customer-defined savings categories within the account that act as sub-accounts. The customer may create savings categories and set parameters such as the goal amount to be reached, the time to reach the goal, how much (in terms of a percentage or an amount) to be allocated to each category per deposit, etc. In those embodiments in which the parameters include how much to be allocated to each category per deposit, as the customer deposits funds into the dynamic savings allocation account, the deposit is automatically allocated to each savings category as defined by the customer. As goals are reached, customers may opt to take advantage of group purchasing benefits offered by the financial institution for some in-demand items. Alternatively, the financial institution, in partnering with third-party vendors may perform targeted sales campaigns.

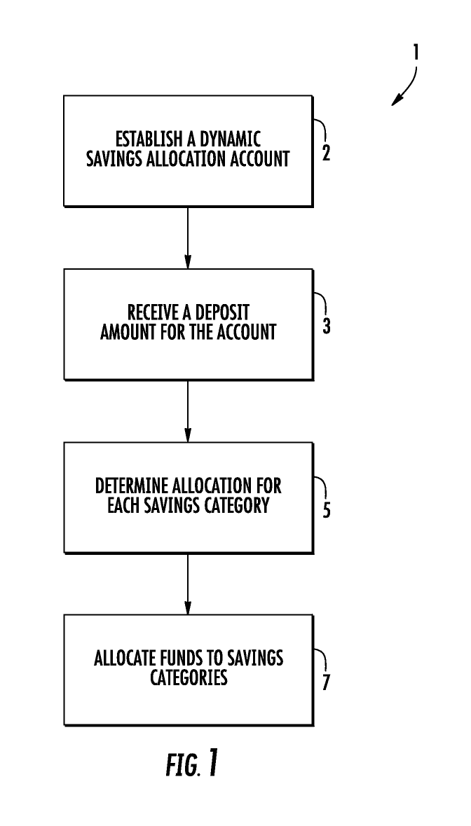

FIG. 1 is a high level flow diagram of a general method 1 for dynamic savings allocation (DSA). At block 2, a dynamic savings allocation account is established by the financial institution. Establishing the account is not limited to creating a new account but may also include incorporating the dynamic savings allocation functionality into an already-existing account. Furthermore, if the account established is a new account, the account may be established by any typical account opening methods. For instance, a customer may establish the new account in-person at a financial institution office. Alternatively, the account may be established by telephone, mail, internet, or any other method.

Upon establishing the DSA account, the financial institution receives a deposit amount for the account as illustrated at block 3. At block 5, a computing device then determines how the deposit amount should be allocated to one or more customer-defined savings categories based on parameters determined by the customer. Finally, the funds are allocated to the savings categories at block 7.

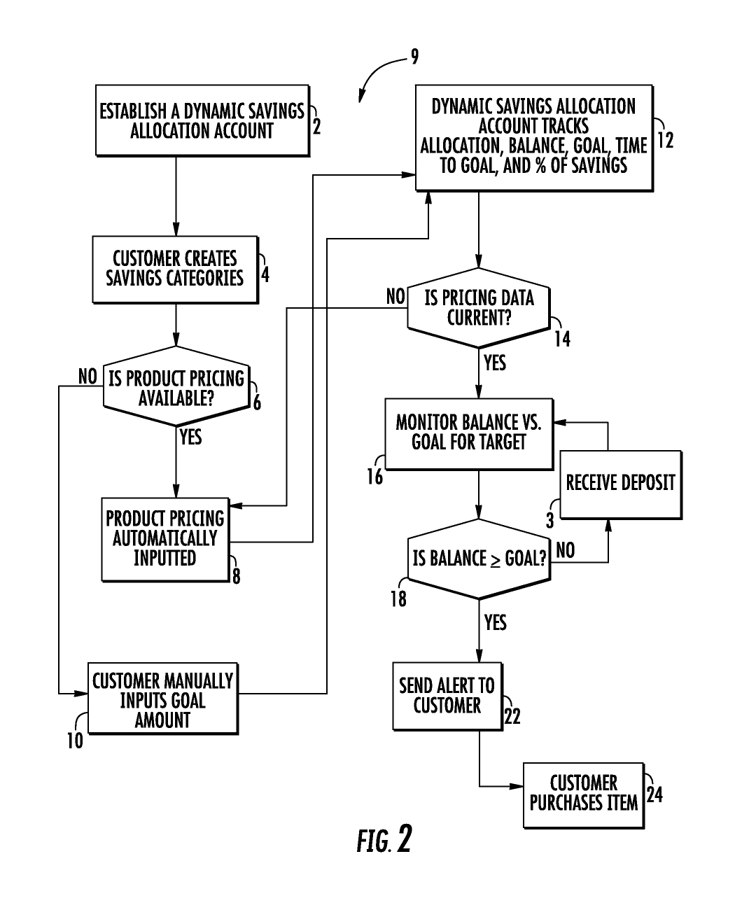

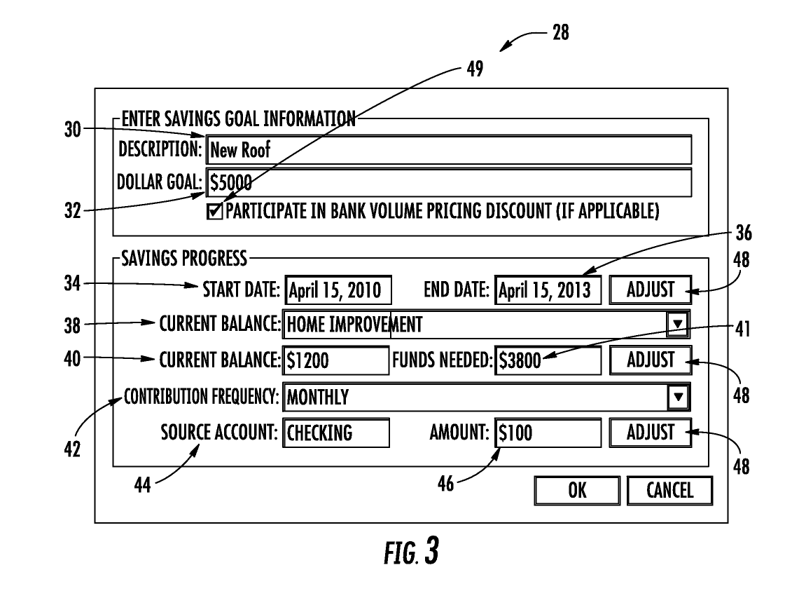

FIG. 2 illustrates method 9 in accordance with one embodiment of the invention. After establishing the dynamic savings allocation account (block 2), at block 4, the customer creates at least one savings category. FIG. 3 illustrates one embodiment of a network-based input form 28 for creating a savings category. As illustrated, when creating a savings category, typically, the customer must provide a description 30 or a name for the category. Next, according to certain embodiments, the customer may be required to determine the goal amount 32 that they wish to achieve for this savings category. Of note, the financial institution may include a database that stores product/service pricing data for commonly saved-for items. If the description of the category 30 is associated with a product/service and the product/service is included in the financial institution's database, the goal amount 32 may be inputted automatically. It should also be noted that the product pricing data may include exclusive discounts or incentives offered as a part of group pricing discounts or an exclusively negotiated price for the financial institution's customers (discussed further below). Additionally, according to other embodiments of the invention, the customer may not be required to enter a savings goal if they do not desire to or if the defined savings category does not warrant a savings goal. For instance, a customer may not have an exact goal in mind for a savings category such as “slush fund” or “rainy day fund.”

Next, the customer may input a savings start date 34. In lieu of or prior to the customer inputting a savings start date, the date may be automatically inputted as the present date or the date of the first anticipated deposit. Likewise, the customer may input a savings end date 36. Alternatively, this date could be automatically generated based on other values inputted. A general category 38 associated with the customer defined savings category may also be selected if desired, for instance from a drop-down menu.

The current balance 40 and funds needed 41 indicate how much is currently allocated to the savings category and how much more is needed to reach the goal amount 32, respectively. When first generating the savings category, the customer may allocate a certain amount to the savings category immediately, or set the current balance 40 to zero and begin saving. The contribution frequency 42 may be selected from, for instance, a drop-down menu or otherwise pre-selected values. The allocation may be made on the date of each deposit, but it is not necessary to allocate a certain amount to each savings category for every deposit. In fact, in certain embodiments, the customer may opt to manually transfer funds within the account to the categories as they see fit.

Source account 44 provides an input for the customer to determine the source account for the funds to be drawn from. As shown in FIG. 3, the source account 44 selected in this embodiment is a checking account. It should be noted, however, that the source account could be an automatic payroll deposit, an annuity payout, or any other funding source. Contribution amount 46 allows for the customer to input a set amount to be allocated to the savings category on a recurring basis (in the example of FIG. 3, the funds are allocated monthly). In other embodiments, the customer is provided with an input to define a percentage of a deposit, such as a payroll deposit, to be allocated to the savings category.

Adjust buttons 48 are provided in order to allow the customer to manipulate the savings category parameters to achieve the desired balance. For instance, the customer could change the goal end date 36, and the periodic amount 46 contributed would be automatically adjusted accordingly. Conversely, the customer could alter the periodic contribution amount 46 or the frequency of contribution 42, and the goal end date 36 would automatically adjust accordingly.

Finally, the customer may opt to participate in a volume pricing discount program 49 or other such type of program if applicable. Group pricing aspects of the present invention are discussed further below.

Returning to the flow diagram of FIG. 2, as discussed briefly above, decision block 6 of the method 9 is to determine whether product/service pricing is available if the customer has selected a specific product or service. As noted above, the financial institution may utilize a database that has product/service pricing information available for commonly saved-for products or services. Furthermore, the database may include pricing that includes exclusive discounts or incentives for the financial institution's customers.

If product pricing is not available, the customer may move to block 10 of the method 9 and manually input a goal amount for the savings category. The manually inputted goal amount may be stored on the database as generic pricing information for future customers saving for the same item. The financial institution may wish to verify such pricing information before it is universally incorporated into the pricing database.

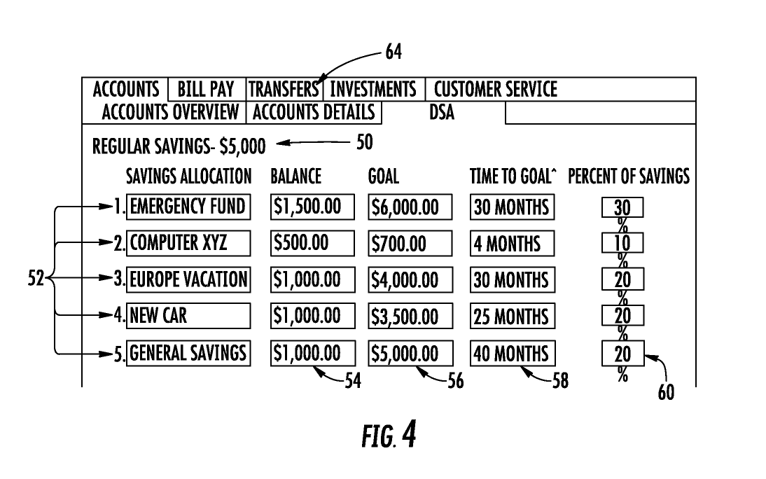

If product pricing is available, the customer may move to block 8 of the method 9 wherein the product pricing is automatically inputted. If an automatic dollar goal is assigned, the customer may choose to override the automated dollar goal and manually adjust the dollar goal accordingly. After pricing is inputted either manually or automatically, the method 9 disclosed in FIG. 2 advances to block 12 where the dynamic savings allocation account tracks allocation, balance, goal, time to goal and percentage of savings. FIG. 4 illustrates one embodiment of a dynamic savings allocation account according to the present invention. In this embodiment, the account includes five savings categories 52 titled “Emergency Fund,” “Computer XYZ,” “Europe Vacation,” “New Car,” and “General Savings.” The second column 54 indicates the balance in each savings category. The sum of the balances total to yield the total amount 50 in the account. The third column 56 lists the goal amount for each category 52. The fourth column 58 gives the time remaining to reach the goal amount 56 for each category 52. Finally, the final column 60 discloses the percentage of total savings allocated to each category. Again, it is important to note that one or more of the columns may be computed automatically based on the information from one or more of the remaining columns from information provided when establishing the account. For instance, in the illustrated embodiment, the time to goal 58 is computed automatically based on a savings category end date provided at the inception of the savings category or as updated throughout the life of the savings category.

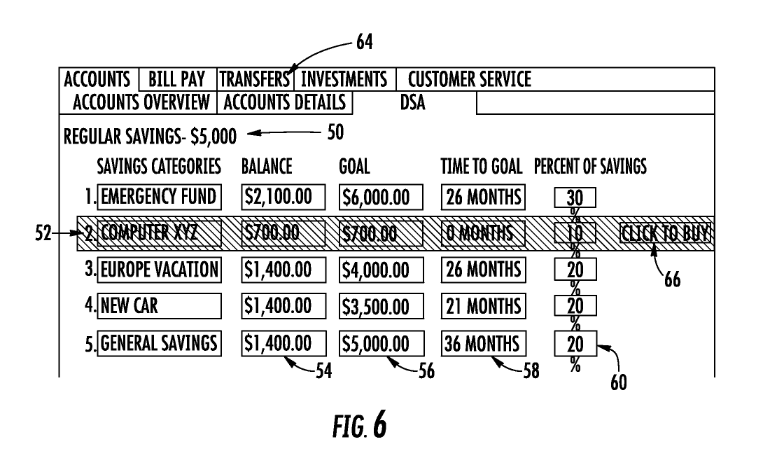

Upon reaching a goal amount 56, if the product being saved-for is capable of being purchased through the financial institution, such as through a group purchase program or targeted sales (discussed below), a “Click to Buy” 66 (FIG. 6) link, or a link effectively similar may appear. In some embodiments, the link 66 leads customers to an online portal to purchase the product. The online portal may be link one or more retailers of the product to the customer. Furthermore, in another embodiment, the customer may opt to automatically purchase the product upon reaching the goal amount (discussed further below). In such cases, the customer would simply receive a notice (e-mail, text message, etc.) that the goal was reached and that the product will be purchased with the accumulated savings as per the “instant purchase” agreement. Also illustrated are various other tabs 64 that may be utilized to navigate different functionalities.

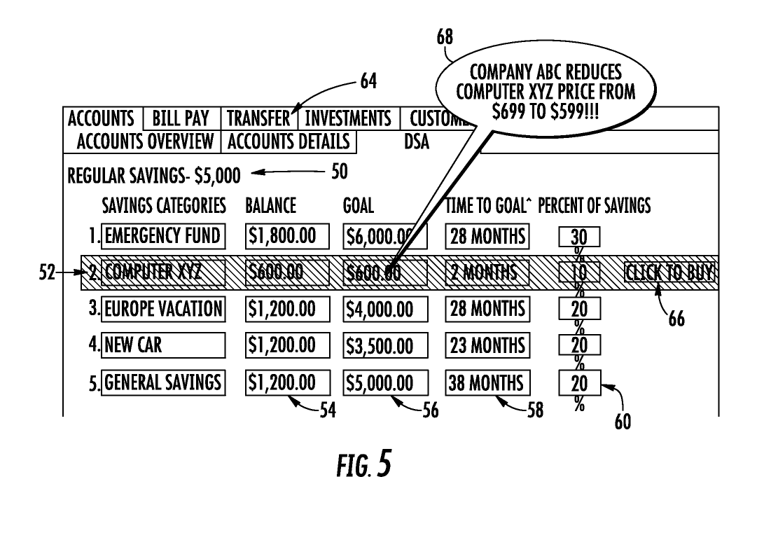

Referring back to FIG. 2, decision block 14 is indicative of the continual tracking of the pricing data. Pricing data may change if the retailer drops its price or, in some cases, if the financial institution brokers a group purchase discount or other exclusive deal. For instance, FIG. 5 illustrates an embodiment where the vendor for a product that the customer is saving for reduces the price. In the embodiment illustrated, the vendor's price reduction lowers the savings category goal to an amount equal to or greater than the already-attained balance. In this embodiment, “Computer XYZ” is a product that may be purchased through the financial institution and, based on the category goal having been achieved, the “Click to Buy” input mechanism 66 appears. If the customer wishes to proceed to purchase the product, they may click the “Click to Buy” input mechanism 66 to purchase. Upon purchase, the funds to pay for Computer XYZ may be deducted from the account, and particularly, directly from the savings category of the product purchased.

If pricing data has not changed, method 9 advances to block 16 where the customer monitors the balance and the goal needed for the target. At decision block 18, it is determined whether the balance is greater than or equal to the goal. If not, the method proceeds to block 3 which is receipt of the next deposit. Upon receipt of the next deposit, the method proceeds back to blocks 16 and 18 to determine if the balance is greater than or equal to the goal. According to one specific embodiment of the invention, if the balance is greater than or equal to the category goal amount 32, an alert may be sent to the customer at block 22. The alert may be sent by any feasible means. For instance, the alert may be made by email, an alert pop-up screen the next time the customer logs in to their online account, an automated telephone call, a text message, etc. As previously discussed, if the product is capable of being sold through the financial institution (by the financial institution or via a third-party vendor), the application may be configured to present the “Click to Buy” input mechanism 66 to allow the customer to purchase the product. FIG. 6 illustrates an example where the category goal 56 has been achieved for a specific savings category 52, namely Computer XYZ. As illustrated, the “Click to Buy” input mechanism 66 is activated based on the category goal 56 having been met.

The method 9 is completed at block 24 where the customer purchases the item and withdraws the saved funds from the savings category.

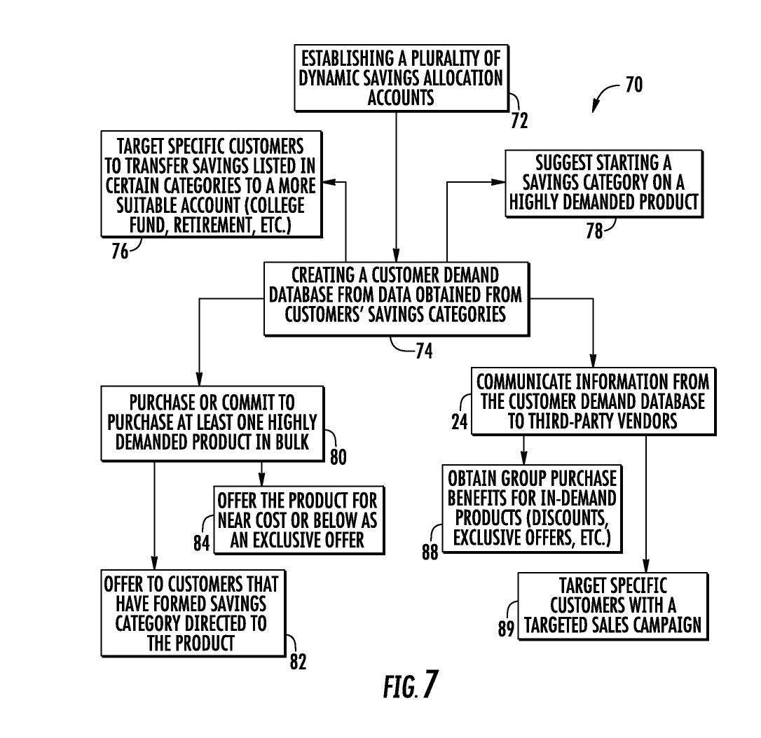

FIG. 7 is a flow diagram of a method 70 for providing financial services. At block 72, a plurality of dynamic savings allocation accounts are established or have already been established by a financial institution. As noted earlier, the accounts do not necessarily have to be new accounts. The dynamic savings allocation functionality may be incorporated into an already-existing account. The dynamic savings allocation account includes one or more customer-defined savings categories.

At block 74, the financial institution may utilize internal data gathered from the plurality of dynamic savings allocation accounts to create a forward-looking customer demand database. Such a customer demand database is very useful and can be utilized in a number of ways. For instance, as shown at block 76, the financial institution may use the data to target specific customers for the purpose of offering the targeted customers the opportunity to open a more suitable account to transfer funds presently allocated to a certain savings category. For example, the financial institution could offer to open a 529 plan for funds allocated to a “College Savings” savings category 52.

Another way to utilize the customer demand database is illustrated at block 78. The database could be utilized to determine highly popular items that numerous customers are saving for. With such data, the financial institution could recommend the top items to other customers. This would lead to even more customers saving for top items, which in turn, would yield a higher amount of deposits as well as increased “demand” for potential group purchase benefits.

Additionally, regarding popular, in-demand products that large numbers of customers are saving for, the financial institution could utilize such data from the database to approach vendors who sell the in-demand product and negotiate a bulk purchase price. This is illustrated at block 80. As shown at block, 82, the financial institution could, in turn, offer the product to customers that have formed savings categories 52 directed to the product.

In specific embodiments of the invention, the financial institution may acquire products or services in bulk, while in other embodiments the financial institution may offer products or services on behalf of a third-party entity. Actually purchasing and taking on inventory from the vendor maximizes the amount of profit the financial institution could receive from sales of the demanded product as the financial institution would essentially become a retailer. It may not always be feasible, however, for the financial institution to become a vendor of the product and risking having capital tied into a non-financial service-related product and having inventory of a product that the financial institution cannot sell. One method that the financial institution could ensure that the product would be sold is illustrated at block 84. As illustrated, the financial institution could forward nearly all of the discounted savings to the customer and offer the highly demanded product for near cost. Furthermore, the financial institution could feasibly offer the product for a small loss. This would create a “buzz” as the financial institution would likely be offering the highly demanded product at a price less than any other retailer. This “buzz” would serve as a means of marketing and would likely lead to a substantial spike in new customers opening accounts with the financial institution.

In most cases in which the financial institution wishes to offer a third-party product, the financial institution could approach vendors of the product to negotiate group purchase benefits to obtain discounts or exclusive offers for the customers saving for the product. This is shown at block 88. In such situations, the financial institution could generate revenue by sharing in the profits from the sales or receiving a portion of the discount, while not physically taking on inventory of the product. Such a group purchase model brings value to all parties involved (e.g., the customers, the financial institution, and the vendors).

Oftentimes, the customer will not be saving for a specific product, but rather a more general product such as a “television” or a “computer.” In such situations where a large number of customers are saving for general products, the financial institution could approach vendors in hopes of brokering a deal for a discount on, for instance, vendor gift cards. For example, if the customer demand database indicates that a large number of customers are saving for a certain type of product (e.g., electronics), the financial institution could approach a type of vendor that specializes in the area and obtain an exclusive offer for purchasing gift cards (e.g., receiving a gift card value higher than the amount paid for the gift card). This would be beneficial for the vendor as it could increase the likelihood the customers purchased from them, as well as generate instant revenue from gift card purchases. Furthermore, as the financial institution brokers more deals and exclusive offers for their customers, the financial institution would likely obtain an increase in new accounts from those who wish to be included in the rewards programs.

Furthermore, with the data obtained from the customer demand database, the financial institution could provide third-party vendors with various groups of consumers that would be prime candidates for a targeted sales campaign, as indicated at block 89. Targeted sales campaigns could be effective on customers that are saving for specific products as well as more general categories of products. For example, if the financial institution could provide data to a vendor that indicated that a large number of customers were presently saving for the type of product the vendor provides, the vendor could generate a targeted offer to just those customers. The vendor could send the offer directly to the customer if the customer opted to receive such third-party offers. Alternatively, the offer could be made through the financial institution as an exclusive offer, and thus maintain the customers' privacy. In such campaigns, the financial institution could generate revenue from the vendor in any number of ways such as a percentage of sales, an up front fee for marketing to the number of customers, etc.

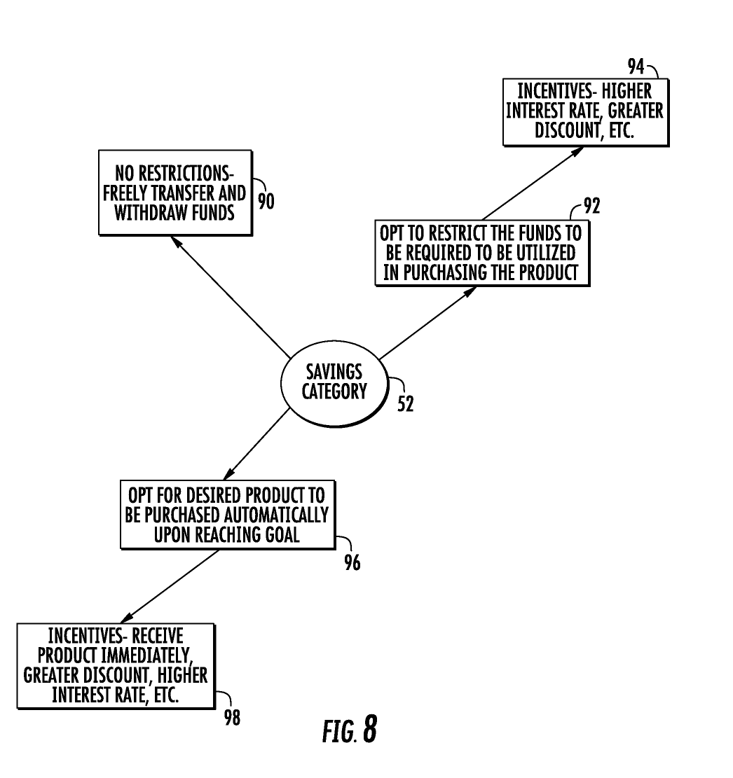

FIG. 8 illustrates the ability for customers to tailor savings categories or the entire account to their needs. As shown in FIG. 8, each savings category 52 may act as a standard savings account, as shown in block 90, where the funds are not restricted and the customer may freely withdraw funds or transfer to different savings categories 52 or accounts without penalty. However, the customer may opt to include restrictions on the funds in exchange for certain incentives. For instance, at block 92, the customer could opt to restrict the use of funds in a savings category 52, such that funds may be required to be utilized in purchasing the product being saved for. Once the customer reached the goal amount, they could purchase the product by any number of ways that could be verified by the financial institution. For example, customers could purchase the product from a link provided by the financial institution such as the “Click to Buy” input mechanism 66 discussed above, the financial institution could issue a voucher for the product at a desired vendor, or some form of electronic funds transfer from the financial institution to the vendor.

The customer may be provided with incentives as shown at block 94 in order to restrict the funds in the savings category. Such incentives could include a higher interest rate than the standard no restriction savings category (block 90), a greater discount or “super” exclusive offer on the product they wish to purchase, etc. The financial institution could benefit from customers that restrict their funds in such a manner as they could provide “hard” data to vendors of financial institution customers that have committed to buying the product. Of course, if the customer ultimately opted to not purchase the product using the restricted funds, the financial institution may enforce some sort of financial penalty previously agreed to by the customer.

A similar restriction option is illustrated at block 96 where the customer may opt to have the product purchased automatically upon reaching the goal. The financial institution would benefit similarly as they could utilize such “definite purchasing” data in brokering deals with third-party vendors. As incentive, the customer would receive their product (either by shipment or picking up in-store) immediately following reaching the goal amount. Other incentives could also be provided such as a higher interest rate or greater discount on the product.

System and method embodiments according to the present invention are advantageous for several reasons. For example, providing a dynamic savings allocation account option to those who have routinely used the “envelope” method for allocation should serve to increase the financial institution's deposit base. Furthermore, it would serve to reduce the number of individual accounts of customers that have previously attempted to allocate simply by opening multiple different accounts. Additionally, as the customer base grows based on utilization of the dynamic savings allocation account, the financial institution could utilize customer tendency data in brokering exclusive offers with third-party vendors, utilize targeted sales campaigns, etc. to provide “rewards program” type of services to the customers while, at the same time, building relationships with third-party vendors.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for dynamic savings allocation, the method comprising:
establishing, for a financial institution customer, a dynamic savings allocation account, the account including at least one customer-defined savings category;
receiving a deposit amount for the account;
determining, via a computing device processor, for the deposit amount, an amount to be allocated to the at least one customer-defined savings category; and
allocating the determined amount to the at least one customer-defined savings category.

2. The method of claim 1, wherein the at least one customer-defined savings category includes parameters selected by the customer comprising a category name, a goal amount desired to be saved, a percentage of savings or the deposit amount to be allocated to the savings category, a time period to reach a desired amount, or a combination thereof.

3. The method of claim 2, wherein the at least one customer-defined savings category includes parameters comprising a goal amount desired to be saved, a percentage of total savings to be allocated to the savings category, and a time period to reach a desired amount, wherein the customer may define two of the parameters and the third parameter is automatically generated.

4. The method of claim 1, wherein the customer defines an amount or percentage to be deposited to the dynamic savings allocation account, the amount to be deposited to the dynamic savings allocation account being a recurring amount that is deposited each customer-defined time period.

5. The method of claim 4, wherein the amount to be deposited to the dynamic savings allocation account is automatically drafted from another account or is deposited by a third-party.

6. The method of claim 1, wherein the at least one customer-defined savings category includes a category name that is manually inputted by the customer or is selected from a list of names provided to the customer.

7. The method of claim 1, wherein at least one of the at least one customer-defined savings category includes a category name that represents a specific product or service and a goal amount that is approximately equal to the cost of the specific product or service.

8. The method of claim 7, wherein the goal amount is automatically inputted by the computing device processor based on the category name inputted that represents a specific product or service.

9. The method of claim 1, wherein the dynamic savings allocation account includes more than one customer-defined savings categories.

10. The method of claim 9, wherein each customer-defined savings category includes a percentage of total savings in the account to be allocated to each savings category, wherein a sum of the percentages of all savings categories equals 100 percent.

11. The method of claim 10, wherein no further amount is allocated to a savings category in which the desired goal has been reached.

12. The method of claim 9, wherein the customer defines a specific amount or percentage to be allocated to one or more savings categories for each deposit.

13. A system for dynamic savings allocation, the system comprising an apparatus that includes a processor, memory, and an application configured to determine for a deposit amount, an amount to be allocated to at least one savings category within a dynamic savings allocation account, wherein the at least one savings categories includes customer-defined parameters for savings allocation.

14. The system of claim 13, wherein the customer-defined parameters include a category name, a goal amount desired to be saved, a percentage of savings or deposit to be allocated to the at least one savings category, a time period to reach a desired amount, or a combination thereof.

15. The system of claim 14, wherein the customer-defined parameters comprise a goal amount desired to be saved, a percentage of total savings to be allocated to the savings category, and a time period to reach a desired amount, wherein the customer defines two of the parameters and the third parameter is automatically generated.

16. The system of claim 13, wherein an amount to be deposited to the dynamic savings allocation account is a recurring amount that is deposited each customer-defined time period.

17. The system of claim 16, wherein the amount to be deposited to the dynamic savings allocation account is automatically drafted from another account or is deposited by a third-party.

18. The system of claim 13, wherein the at least one savings category includes a category name that is manually inputted by the customer or is selected from a list of names provided to the customer.

19. The system of claim 13, wherein at least one of the savings categories includes a category name that represents a specific product or service and a goal amount that is approximately equal to the cost of the specific product or service.

20. The system of claim 19, wherein the goal amount is automatically determined based on the category name inputted that represents a specific product.

21. The system of claim 13, wherein the dynamic savings allocation account includes more than one savings categories.

22. The system of claim 21, wherein each savings category includes a percentage of total savings in the account to be allocated to each savings category parameter, wherein a sum of the percentages of all savings categories equals 100 percent.

23. The system of claim 22, wherein no further amount is allocated to a savings category in which the desired goal has been reached.

24. The system of claim 21, wherein the customer defines a specific amount or percentage to be allocated to one or more savings categories for each deposit.

25. A method for dynamic savings allocation, the method comprising:
providing a dynamic savings allocation account to a customer, wherein the account is capable of having one or more customer-defined savings categories;
wherein after the customer has created one or more customer-defined savings categories within the account, receiving a deposit amount for the account;
determining, via a computing device processor, for the deposit amount, an amount to be allocated to the one or more customer-defined savings categories; and
allocating the determined amount to the one or more customer-defined savings categories.

26. The method of claim 25, wherein the one or more customer-defined savings categories include parameters selected by the customer comprising a name, a goal amount desired to be saved, a percentage of total savings to be allocated to the savings category, a time period to reach a desired amount, or a combination thereof.

27. The method of claim 26, wherein the one or more customer-defined savings categories include parameters comprising a goal amount desired to be saved, a percentage of total savings to be allocated to the savings category, and a time period to reach a desired amount, wherein the customer defines two of the parameters and the third parameter is automatically generated.

28. The method of claim 25, wherein the customer defines an amount to be deposited to the dynamic savings allocation account, the amount to be deposited to the dynamic savings allocation account being a recurring amount that is deposited each customer-defined time period.

29. The method of claim 28, wherein the amount to be deposited to the dynamic savings allocation account is automatically drafted from another account or is deposited by a third-party.

30. The method of claim 25, wherein the one or more customer-defined savings categories include a category name that is manually inputted by the customer or is selected from a list of names provided to the customer.

31. The method of claim 25, wherein at least one of the one or more customer-defined savings categories include a category name that represents a specific consumer product and a goal amount that is approximately equal to the consumer cost of the specific consumer product.

32. The method of claim 31, wherein the goal amount is automatically inputted by the computing device processor based on the category name inputted that represents a specific consumer product.

33. The method of claim 25, wherein the dynamic savings allocation account includes more than one customer-defined savings categories.

34. The method of claim 33, wherein each customer-defined savings category includes a percentage of total savings in the account to be allocated to each savings category parameter, wherein the sum of the percentages of all savings categories equal 100%.

35. The method of claim 34, wherein no further amount is allocated to a savings category in which the desired goal has been reached.

36. The method of claim 33, wherein the customer defines a specific amount to be allocated to one or more savings categories for each deposit.

37. A computer program product comprising:
a non-transitory computer-readable medium comprising:
a first set of codes for causing a computer to determine, for a received deposit amount for a dynamic savings allocation account, an amount to be allocated to one or more customer-defined savings categories; and
a second set of codes for causing a computer to deposit the deposit amount in the dynamic savings allocation account and allocate a portion of the deposit amount to the one or more customer-defined savings categories.

38. The computer program product of claim 37, further comprising a third set of codes for causing a computer to receive parameters for the one or more customer-defined savings categories, wherein the parameters are selected by a customer and comprise a name, a goal amount desired to be saved, a percentage of total savings or deposit amount to be allocated to the savings category, a time period to reach a desired amount, or a combination thereof.

39. The computer program product of claim 38, wherein the parameters comprise a goal amount desired to be saved, a percentage of total savings to be allocated to the savings category, and a time period to reach a desired amount, wherein the computer program product further comprises a fourth set of codes for causing a computer to automatically generate at least one of the parameters based on other parameters defined by the customer.

40. The computer program product of claim 38, further comprising a fifth set of codes for causing a computer to present an electronic input form to the customer for defining the parameters for the one or more customer-defined savings categories.

41. The computer program product of claim 37, further comprising a sixth set of codes for causing a computer to automatically input a goal amount for at least one of the one or more customer-defined savings categories, wherein the goal amount is approximately equal to the cost of a specific consumer product or service, the specific consumer product or service being identified by parameters defined by the customer.

42. The computer program product of claim 37, further comprising a seventh set of codes for causing a computer to generate more than one customer-defined savings categories within the dynamic savings allocation account.

43. The computer program product of claim 37, further comprising an eighth set of codes for causing a computer to generate an alert to a customer when a goal amount is reached for the one or more customer-defined savings categories.
